(19) United States
(12) Patent Application Publication
(10) Pub. No.: US 2025/0141890 A1
(43) Pub. Date: May 1, 2025

(54) INFORMATION SECURITY THREAT DETERMINATION METHOD AND INFORMATION SECURITY THREAT DETERMINATION DEVICE

(71) Applicant: INSTITUTE FOR INFORMATION INDUSTRY, TAIPEI CITY (TW)

(72) Inventors: SHENG-YANG WU, TAIPEI CITY (TW); Chia-Wei TIEN, TAIPEI CITY (TW)

(21) Appl. No.: 18/518,454

(22) Filed: Nov. 23, 2023

(30) Foreign Application Priority Data
Oct. 26, 2023 (TW) 112140972

(51) Int. Cl. H04L 9/40

(52) U.S. Cl. CPC H04L 63/1416

(57) ABSTRACT

An information security threat determination method and an information security threat determination device are provided. The information security threat determination method and the information security threat determination device are applicable to a network system including a terminal, a core network and a server. The information security threat determination method includes the following steps: receiving information about an abnormal event occurring in the network system; performing a cause and effect tree inspection procedure to generate a plurality of tracing causes according to the abnormal event and deploying a virtual terminal and a virtual server to communicate through the core network to verify whether each tracing cause will cause the abnormal event, thereby generating inspection result; and performing decision chain procedure to determine the abnormal event as non-information security threat event or information security threat event according to the inspection result.

### CROSS-REFERENCE TO RELATED PATENT APPLICATION

This application claims the benefit of priority to Taiwan Patent Application No. 112140972, filed on Oct. 26, 2023. The entire content of the above identified application is incorporated herein by reference.

Some references, which may include patents, patent applications and various publications, may be cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF THE PRESENT DISCLOSURE

The present disclosure relates to a threat determination method and a threat determination device, and more particularly to an information security threat determination method and an information security threat determination device.

### BACKGROUND OF THE PRESENT DISCLOSURE

After the fifth generation mobile communication technology (5G) network adopts an open architecture, network elements that comply with standards and interface specifications can be networked, and abnormal status in the overall 5G network can be detected from different aspects through external systems.

In addition, the information security central control platform of 5G networks usually receives a large number of abnormal event warnings, but only a small number of abnormal events are actually caused by information security threats. Therefore, there is an urgent need in the technical field for a method and device that can effectively verify information security threats.

### SUMMARY OF THE PRESENT DISCLOSURE

In response to the above-referenced technical inadequacies, the present disclosure provides an information security threat determination method and an information security threat determination device in view of the shortcomings of the existing technology, which can determine abnormal events as non-information security threat events or information security threat events.

In order to solve the above-mentioned problems, one of the technical aspects adopted by the present disclosure is to provide an information security threat determination method applicable to a network system including a terminal, a core network and a server, and including following steps: receiving information about an abnormal event occurring in the network system; executing a cause and effect tree inspection procedure to generate a plurality of tracing causes according to the abnormal event and deploying a virtual terminal and a virtual server to communicate through the core network to verify whether each tracing cause causes the abnormal event so as to generate an inspection result; and executing a decision chain procedure to determine the abnormal event as a non-information security threat event or an information security threat event according to the inspection result.

In order to solve the above-mentioned problems, another one of the technical aspects adopted by the present disclosure is to provide an information security threat determination device applicable to a network system including a terminal, a core network and a server, and including: a storage and a processor. The storage is configured to store information about an abnormal event occurring in the network system. The processor is electrically connected to the storage and configured to execute following steps: executing a cause and effect tree inspection procedure to generate a plurality of tracing causes according to the abnormal event and deploying a virtual terminal and a virtual server to communicate through the core network to verify whether each tracing cause causes the abnormal event so as to generate an inspection result; and executing a decision chain procedure to determine the abnormal event as a non-information security threat event or an information security threat event according to the inspection result.

These and other aspects of the present disclosure will become apparent from the following description of the embodiment taken in conjunction with the following drawings and their captions, although variations and modifications therein may be affected without departing from the spirit and scope of the novel concepts of the present disclosure.

### BRIEF DESCRIPTION OF THE DRAWINGS

The described embodiments may be better understood by reference to the following description and the accompanying drawings, in which:

FIG. 1 is a functional block diagram of the information security threat determination device according to an embodiment of the present disclosure;

FIG. 2 is a flow chart of the information security threat determination method according to an embodiment of the present disclosure;

FIG. 3 is a flow chart of the cause and effect tree inspection procedure according to an embodiment of the present disclosure;

FIG. 4 is a schematic diagram of the processor of the information security threat determination device configured to execute the cause and effect tree inspection procedure according to an embodiment of the present disclosure;

FIG. 5 is a flow chart of the end-to-end probing procedure according to an embodiment of the present disclosure;

FIG. 6 is a schematic diagram of the processor of the information security threat determination device configured to execute the end-to-end probing procedure according to an embodiment of the present disclosure;

FIG. 7 is a flow chart of the key data retrieval procedure according to an embodiment of the present disclosure; and

FIG. 8 is a flow chart of the decision chain procedure according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

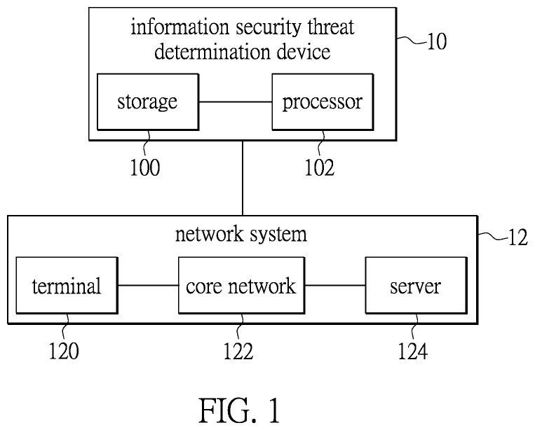

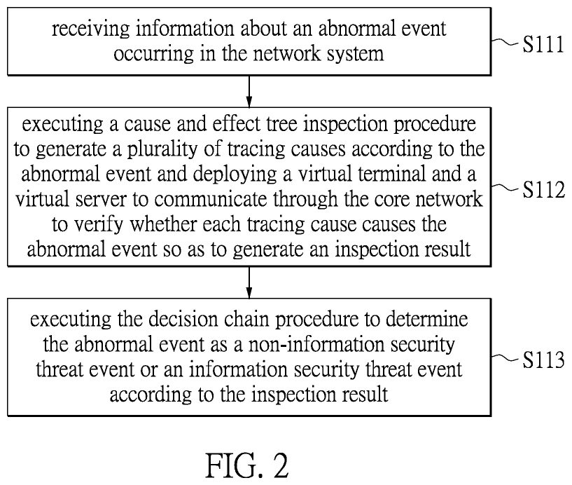

Reference is made to FIGS. 1 and 2. FIG. 1 is a functional block diagram of the information security threat determination device according to an embodiment of the present disclosure, and FIG. 2 is a flow chart of the information security threat determination method according to an embodiment of the present disclosure. As shown in FIG. 1, the information security threat determination device 10 of this embodiment is applicable to a network system 12 including a terminal 120, a core network 122 and a server 124 (i.e., the information security threat determination device 10 can be coupled to the network system 12), and the information security threat determination device 10 includes a storage 100 and a processor 102.

The storage 100 is configured to store information about an abnormal event occurring in the network system 12 (i.e., reflecting the content of the abnormal event, but not shown in FIG. 1). The processor 102 is electrically connected to the storage 100 and can be implemented by hardware (e.g., central processing unit and memory) together with software and/or firmware. However, the present disclosure is not limited to the specific implementations of the storage 100 and the processor 102.

As shown in FIG. 2, the information security threat determination method of this embodiment can be executed by the information security threat determination device 10 and includes the following steps.

S111: receiving information about an abnormal event occurring in the network system.

Specifically, the information security threat determination device 10 may be configured to receive information about an abnormal event occurring in the network system 12 and store the information about the abnormal event into the storage 100. In this embodiment, the network system 12 may be a system of the 5G network, and the information about the abnormal event may be generated by an external system of the 5G network. The terminal 120, the core network 122 and the server 124 may be the user equipment (UE), the core the network and the data network (DN) of the 5G network respectively, and the core network 122 is coupled between the terminal 120 and the server 124. In addition, the aforementioned external system may include Operations and Maintenance (OAM) of the 5G network system, the information security detection system and the network segment traffic monitoring system, etc., but the present disclosure is not limited thereto.

Generally speaking, the core network of a 5G network can include Access and Mobility Function (AMF), Session Management Function (SMF) and User Plane Function (UPF), etc., and the OAM system can detect abnormal operation of the Network Function (NF) of the core network. In addition, the information security detection system can detect events such as abnormal UE login, and the network segment traffic monitoring system can detect abnormal traffic events on the network segment (e.g., N2 interface, N3 interface or N6 interface). That is to say, the aforementioned external system can effectively detect the abnormal status of the overall 5G network from different aspects, and the information security threat determination device 10 can receive information about an abnormal event through the aforementioned external system.

According to the above content, different systems (i.e., the OAM system, the information security detection system, the network segment traffic monitoring system, etc.) can detect the abnormal event from different sources. In addition, different abnormal events detected by different systems at the same time have a high probability of originating from the same security threat. Therefore, in other embodiments, if the information security threat determination device 10 receives information about a plurality of abnormal events detected by the external system at the same time, the information security threat determination device 10 can also be configured to select one of the plurality of abnormal events to serve as the primary target for source analysis.

S112: executing a cause and effect tree inspection procedure to generate a plurality of tracing causes according to the abnormal event and deploying a virtual terminal and a virtual server to communicate through the core network to verify whether each tracing cause causes the abnormal event so as to generate an inspection result.

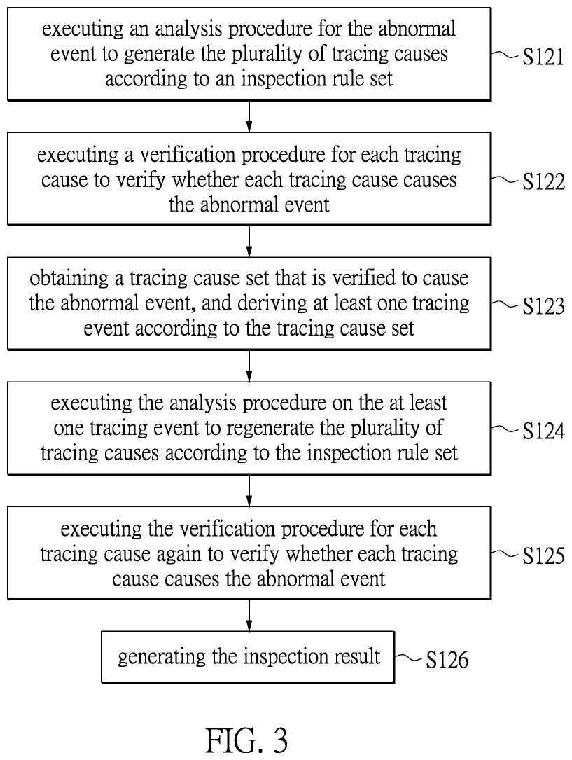

Further, the processor 102 may be configured to execute a cause and effect tree inspection procedure to generate a plurality of tracing causes (not shown in FIG. 1) according to the abnormal event and deploy a virtual terminal and a virtual server (not shown in FIG. 1) to communicate through the core network to verify whether each tracing cause will cause an abnormal event. In addition, reference is made to FIG. 3, which is a flow chart of the cause and effect tree inspection procedure according to an embodiment of the present disclosure. As shown in FIG. 3, the cause and effect tree inspection procedure may include the following steps.

S121: executing an analysis procedure for the abnormal event to generate the plurality of tracing causes according to an inspection rule set.

S122: executing a verification procedure for each tracing cause to verify whether each tracing cause causes the abnormal event.

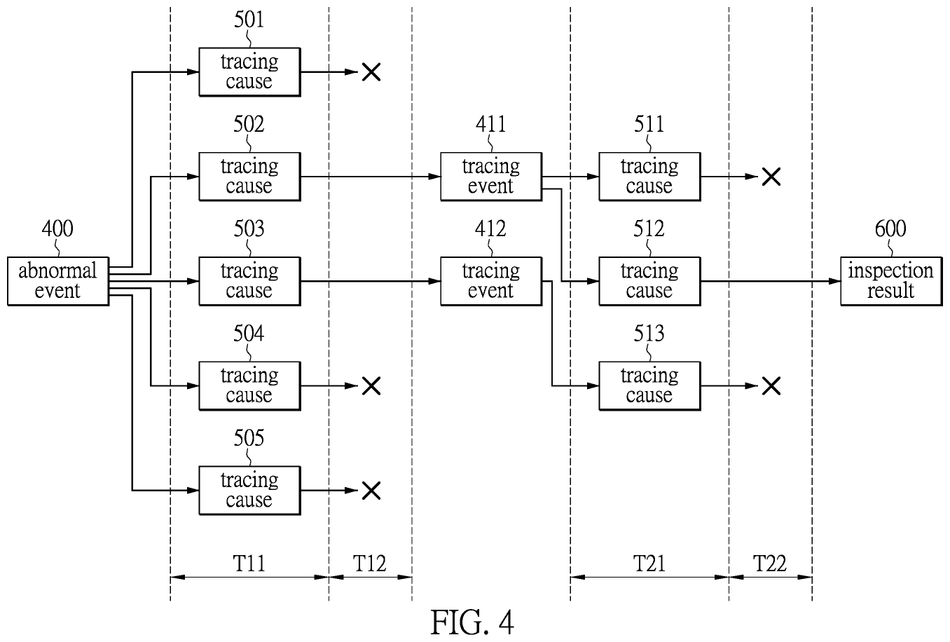

Reference is made to FIG. 4. FIG. 4 is a schematic diagram of the processor of the information security threat determination device configured to execute the cause and effect tree inspection procedure according to an embodiment of the present disclosure. As shown in FIG. 4, during the time period T11 when the analysis procedure is executed for the abnormal event 400, the processor 102 may generate a plurality of tracing causes corresponding to the abnormal event 400 according to an inspection rule set (not shown in FIG. 4). To facilitate the following description, this embodiment takes as an example that the processor 102 generates five tracing causes 501 to 505 corresponding to the abnormal event 400, but the present disclosure is not limited thereto.

Specifically, the inspection rule set may include a plurality of inspection rules. In addition to being pre-set, the plurality of inspection rules can also be added through the decision chain procedure, and the plurality of inspection rules define the tracing causes corresponding to different abnormal events. For example, the plurality of inspection rules can define the tracing causes including “NF's CPU is fully loaded”, “NF's memory is fully loaded”, “NF's storage is fully loaded”, “N3 interface data flow is blocked” and “UE's registration configuration has been maliciously tampered with” corresponding to the abnormal event “the network speed becomes slow after the UE (i.e. the terminal 120) logs into the 5G network”, but the present disclosure is not limited thereto. Therefore, when the abnormal event 400 is the above-mentioned abnormal event, the processor 102 can generate the above-mentioned tracing causes.

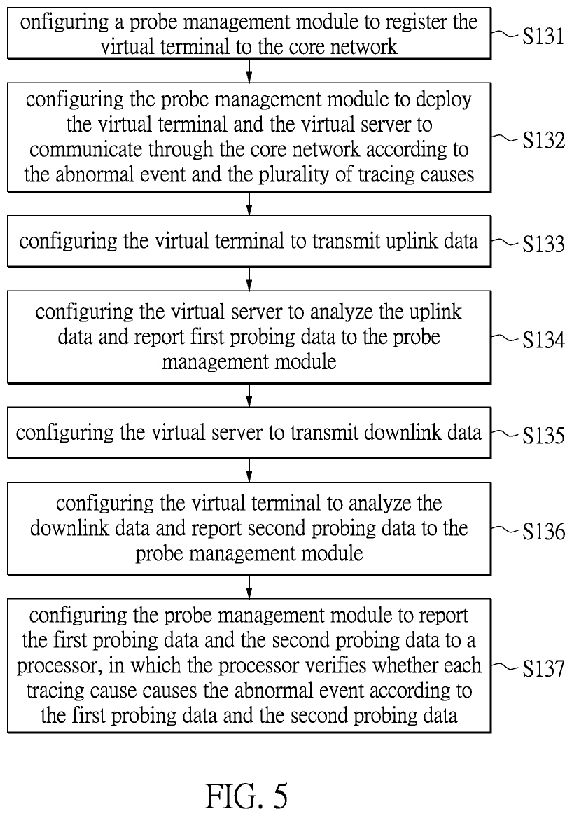

Then, during the time period T12 in which the verification procedure is executed for each tracing cause, the processor 102 may deploy the virtual terminal 120 and the virtual server 124 to communicate through the core network 122 to verify whether each tracing cause causes the abnormal event 400. In order to facilitate understanding, in this embodiment, for tracing causes that are verified not to cause the abnormal event 400, a cross will be labeled on the backend to indicate exclusion. In addition, the verification procedure executed for each tracing cause may include an end-to-end probing procedure. Reference is made to FIG. 5, which is a flow chart of the end-to-end probing procedure according to an embodiment of the present disclosure. As shown in FIG. 5, the end-to-end probing procedure may include the following steps.

S131: configuring a probe management module to register the virtual terminal to the core network;

S132: configuring the probe management module to deploy the virtual terminal and the virtual server to communicate through the core network according to the abnormal event and the plurality of tracing causes;

S133: configuring the virtual terminal to transmit uplink data;

S134: configuring the virtual server to analyze the uplink data and report first probing data to the probe management module;

S135: configuring the virtual server to transmit downlink data;

S136: configuring the virtual terminal to analyze the downlink data and report second probing data to the probe management module; and

S137: configuring the probe management module to report the first probing data and the second probing data to a processor, in which the processor verifies whether each tracing cause causes the abnormal event according to the first probing data and the second probing data.

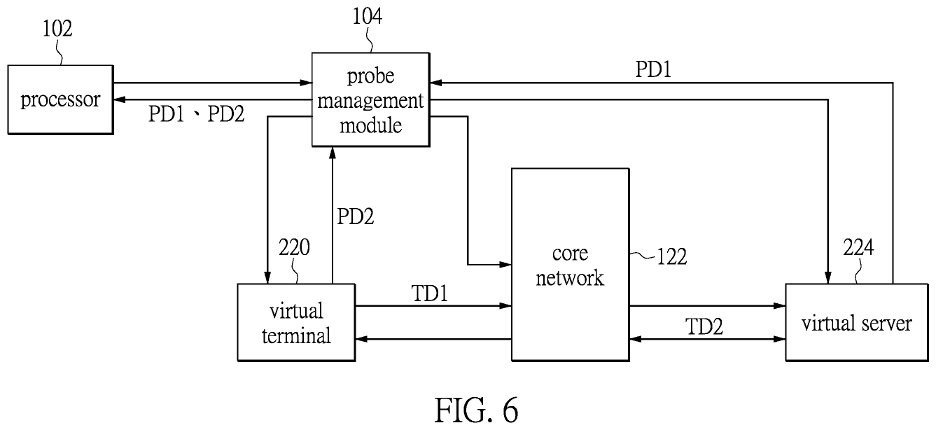

Specifically, the probe management module can also be implemented by hardware combined with software and/or firmware. However, the present disclosure does not limit the specific implementation of the probe management module. Reference is made to 6. FIG. 6 is a schematic diagram of the processor of the information security threat determination device configured to execute the end-to-end probing procedure according to an embodiment of the present disclosure. To facilitate the following description, this embodiment takes the processor 102 executing the end-to-end probing procedure for the tracing cause 501 as an example. As shown in FIG. 6, the processor 102 can be used to configure the probe management module 104 to register the virtual terminal 220 to the core network 122, and configure the probe management module 104 to deploy the virtual terminal 220 and the virtual server 224 to communicate through the core network 122 according to the abnormal event 400 and the tracing cause 501.

In other words, the present disclosure can use the virtual terminal 220 to simulate the operation of a specific UE, and the virtual server 224 is a virtual data network. Next, the probe management module 104 can configure the virtual terminal 220 to transmit the uplink data TD1. The uplink data TD1 transmitted by the virtual terminal 220 will be transmitted to the virtual server 224 through the core network 122. In addition, the virtual server 224 may be configured to analyze the received uplink data TD1 and report the first probe data PD1 to the probe management module 104.

Correspondingly, the probe management module 104 can configure the virtual server 224 to transmit the downlink data TD2, and the downlink data TD2 transmitted by the virtual server 224 will be transmitted to the virtual terminal 220 through the core network 122. In addition, the virtual terminal 220 may be configured to analyze the received downlink data TD2 and report the second probing data PD2 to the probe management module 104. The present disclosure does not limit the specific contents of the uplink data TD1 transmitted by the virtual terminal 220 and the downlink data TD2 transmitted by the virtual server 224. Furthermore, the probe management module 104 can be configured to report the first probing data PD1 and the second probing data PD2 to the processor 102 and the processor 102 verifies whether the tracing cause 501 causes the abnormal event 400 according to the first probing data PD1 and the second probing data PD2.

Furthermore, this embodiment uses the end-to-end probing procedure to achieve the following goals: “detecting whether the UE/DN end transmission data has been tampered with”, “detecting whether the system is subject to DoS attacks”, “detecting whether the N2/N3/N6 interface connection is stable” and “detecting whether the relevant operating records of the UE/base station (e.g., gNB) have been tampered with”, etc., but the present disclosure is not limited thereto. In the case of using the end-to-end probing procedure to “detecting whether the UE end transmission data has been tampered with”, the uplink data TD1 transmitted by the virtual terminal 220 may be security-sensitive data (e.g., medical images, financial data, industry certificates and political pictures, etc.), and the virtual server 224 can generate the first probing data PD1 by comparing the received uplink data TD1 with the information security sensitive data.

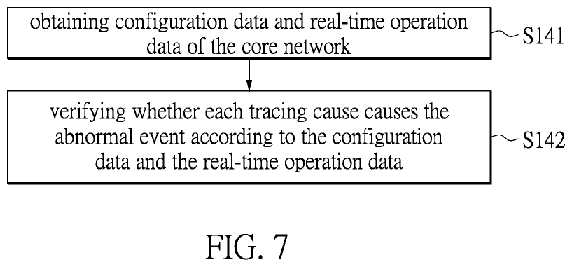

Since the details of using the end-to-end probing procedure to “detecting whether the DN end transmission data has been tampered with” are already the same as those mentioned above, they will not be repeated here. In addition, the verification procedure executed for each tracing cause may also include the key data retrieval procedure. Reference is made to FIG. 7, which is a flow chart of the key data retrieval procedure according to an embodiment of the present disclosure. As shown in FIG. 7, the key data retrieval procedure may include the following steps.

S141: obtaining configuration data and real-time operation data of the core network; and

S142: verifying whether each tracing cause causes the abnormal event according to the configuration data and the real-time operation data.

Specifically, the configuration data of the core network 122 can be the configuration data of the NF, which can be used to verify whether the current tracing cause causes the abnormal event 400. In addition, the real-time operation data of the core network 122 may include the health of each component of the core network, the operating resource usage, the network transmission performance, various logs of NF, etc.

Taking the above content as an example, when using the end-to-end probing procedure to “detecting whether the N2/N3/N6 interface connection is stable”, if the processor 102 determines that the N2/N3/N6 interface connection is unstable, the processor 102 can also obtain the configuration data and the real-time operation data of the core network 122 to verify whether the N2/N3/N6 interface connection is unstable due to malicious operations. In addition, the processor 102 can also execute specific operations to obtain the configuration data and the real-time operation data of the core network 122 to verify whether the NF of the core network 122 is in normal status.

Further, after executing the analysis procedure and the verification procedure, the processor 102 can eliminate certain tracing causes, but in order to obtain better inspection results, the processor 102 can execute a plurality of rounds of analysis procedures and verification procedures. That is to say, this embodiment uses the principle of the cause and effect tree analysis to find the cause of the abnormal event 400. The advantage of the cause and effect tree analysis used in this embodiment is that the inspection scope can be gradually narrowed to more accurately verify information security threats. Therefore, as shown in FIG. 3, the cause and effect tree inspection procedure may further include the following steps.

S123: obtaining a tracing cause set that is verified to cause the abnormal event, and deriving at least one tracing event according to the tracing cause set;

S124: executing the analysis procedure on the at least one tracing event to regenerate the plurality of tracing causes according to the inspection rule set; and

S125: executing the verification procedure for each tracing cause again to verify whether each tracing cause causes the abnormal event.

As shown in FIG. 4, in response to obtaining the tracing cause set that is verified to cause the abnormal event, including the tracing cause 502 and the tracing cause 503, the processor 102 can derive the tracing event 411 and the tracing event 412 according to the tracing cause 502 and the tracing cause 503. However, the present disclosure is not limited thereto. It should be noted that the inspection rule set may also include rules for deriving tracing events according to tracing causes. In addition, during the time period T21 when the analysis procedure is executed for the tracing event 411 and the tracing event 412, the processor 102 can regenerate the plurality of tracing causes corresponding to the tracing event 411 and the tracing event 412 according to the inspection rule set. That is to say, the aforementioned inspection rule may also define tracing causes corresponding to different tracing events. To facilitate the following description, this embodiment takes the processor 102 regenerating the tracing cause 511 and the tracing cause 512 corresponding to the tracing event 411 and the tracing cause 513 corresponding to the tracing event 412 as an example, but the present disclosure is not limited thereto.

It can be seen that the analysis procedure executed in the time period T11 may be the first round of analysis procedure, and the analysis procedure executed in the time period T21 may be the second round of analysis procedure. Similarly, the verification procedure executed during the time period T12 may be the first round of verification procedure, and the verification procedure executed during the time period T22 may be the second round verification procedure. In the second round of the verification procedure, the processor 102 can verify whether each of the tracing causes 511 to 513 causes the abnormal event 400. To facilitate the following description, this embodiment only takes the execution of two rounds of analysis procedures and verification procedures as an example. Therefore, after executing the second round of verification procedures, the processor 102 can generate the inspection result 600.

In other words, since this embodiment only takes the execution of two rounds of analysis procedures and verification procedures as an example, after S125 in FIG. 3, the cause and effect tree inspection procedure may also include S126: generating the inspection result. It should be noted that the content of the inspection result 600 can indicate “no information security threat”, “a single information security threat” or “a plurality of information security threats at the same time”, but the present disclosure is not limited thereto. In this embodiment, since the tracing cause 512 that is verified to cause the abnormal event 400 is only associated to the security threat of “malicious network blocking attack”, the processor 102 can generate the inspection result 600 having the content that is indicative of “a single security threat”.

In other embodiments, if it is verified that there are many tracing causes that cause the abnormal event so that the information security threat cannot be accurately identified, the processor 102 can execute the next round of analysis procedures and verification procedures. That is to say, before entering S126 of the cause and effect tree inspection procedure, the processor 102 may also repeatedly execute S123 to S125 until the inspection scope can be narrowed to more accurately verify the information security threat. Since the relevant details are the same as those mentioned above, they will not be repeated here.

On the other hand, as shown in FIG. 2, the information security threat determination method of this embodiment can proceed to S113: executing the decision chain procedure to determine the abnormal event as a non-information security threat event or an information security threat event according to the inspection result.

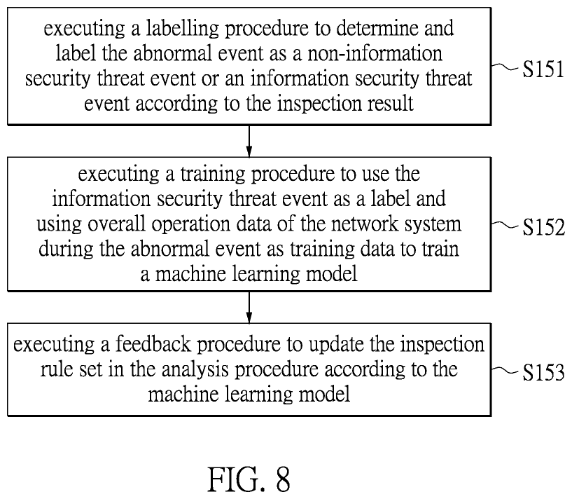

In other words, the processor 102 may be configured to execute the decision chain procedure to determine the abnormal event 400 as a non-information security threat event or an information security threat event according to the inspection result 600. Reference is made to FIG. 8, which is a flow chart of the decision chain procedure according to an embodiment of the present disclosure. As shown in FIG. 8, the decision chain procedure may include the following steps.

S151: executing a labelling procedure to determine and label the abnormal event as a non-information security threat event or an information security threat event according to the inspection result;

S152: executing a training procedure to use the information security threat event as a label and using overall operation data of the network system during the abnormal event as training data to train a machine learning model; and

S153: executing a feedback procedure to update the inspection rule set in the analysis procedure according to the machine learning model.

Specifically, the processor 102 can determine and label the abnormal event 400 as the information security threat event according to the inspection result 400 in response to that one of the plurality of tracing causes 400 verified to cause the abnormal event is associated to an information security threat. Taking the above content as an example, since the tracing cause 512 is associated to the security threat of “malicious network blocking attack”, the processor 102 can not only generate the inspection result 600 indicating “a single security threat”, but also label the abnormal event 400 as an information security threat event according to the inspection result 600.

Correspondingly, if it is verified that the tracing cause 512 that causes the abnormal event 400 is not associated to the information security threat, the processor 102 can not only generate the inspection result 600 indicating “no information security threat”, but also determine and label the abnormal event 400 as a non-information security threat event according to the inspection result 600. In addition, taking the above content as an example, in order to allow the processor 102 to generate the tracing cause 512 earlier, another focus of the decision chain procedure is to update the inspection rule set in the analysis procedure. That is to say, it is hoped that when the processor 102 receives information about the same abnormal event next time, the processor 102 can generate the tracing cause 512 according to the updated inspection rule set in the first round of analysis procedures, so as to save the time and cost of the processor 102 executing the cause and effect tree inspection procedure.

In order to update the inspection rule set in the analysis procedure, the processor 102 can use the information security threat event as a label and use overall operation data of the network system 12 during the abnormal event 400 as training data to train a machine learning model. Then, the processor 102 may update the inspection rule set in the analysis procedure according to the machine learning model. For example, a new inspection rule is added to the current inspection rule set, or the existing inspection rule is removed. Taking the above content as an example, the tracing cause 501 may be identified to have little correlation with the abnormal event 400. In order to avoid increasing the probability of misdetermination, the processor 102 may remove the inspection rule that defines the tracing cause 501 associated to the abnormal event 400 according to the machine learning model. It should be understood that updating the inspection rule set may also be the rule of adjusting the derived tracing event.

Further, the processor 102 can collect the overall operation data of the network system 12 when the abnormal event 400 occurs, and use the overall operation data of the network system 12 as a feature of model training. In addition, the machine learning model can verify what kind of information security threat occurred according to the overall operation data of the network system 12 during the abnormal event 400. For example, the information security threat determination device 10 may also include a database (not shown in the figures), and the database is used to store the overall operation data of the network system 12 when different information security threats occur.

Therefore, the machine learning model can compare the overall operation data of the network system 12 during the abnormal event 400 with the overall operation data stored in the database, and generate threat scores corresponding to different information security threats through the comparison. The higher the threat score, the more likely it is that the corresponding information security threat will occur. After identification, the processor 102 may compare the identification result with the actual result of manual identification. For samples whose identification results are wrong (i.e., the identification results are different from the actual results), the processor 102 can also add the results to the training data and use results to train the machine learning model again.

In other words, the processor 102 can utilize an incremental learning approach to allow the machine learning model to dynamically receive new data and use the new data for learning. Therefore, the machine learning model of this embodiment can continuously learn and correct errors by itself. In this case, this embodiment does not require retraining the entire model. In addition, after a plurality of rounds of training of the machine learning model, in addition to gradually correcting the trace causes generated by the analysis procedure, the machine learning model will also gradually strengthen the accuracy of self-identification of information security threats. If the usage scenarios of the network system 12 changes later, the machine learning model can also self-learn and correct errors to maintain a high degree of accuracy.

To sum up, one of the beneficial effects of the present disclosure is that the information security threat determination method and the information security threat determination device provided by the present disclosure can determine the abnormal event as a non-information security threat event or an information security threat event by virtue of the technical means of “generating a plurality of tracing causes according to an abnormal event and deploying a virtual terminal and a virtual server to communicate through the core network to verify whether each tracing cause causes the abnormal event.” In addition, the information security threat determination method and the information security threat determination device provided by the present disclosure can gradually narrow the inspection scope through a plurality of rounds of analysis procedures and verification procedures to more accurately verify information security threats.

Furthermore, the information security threat determination method and the information security threat determination device provided by the present disclosure can verify whether the tracing cause causes an abnormal event through the end-to-end probing procedure to inspect whether the tracing cause will cause an abnormal event. In addition, the information security threat determination method and the information security threat determination device provided by the present disclosure can gradually correct the tracing causes generated by the analysis procedure through the decision chain procedure.

The foregoing description of the exemplary embodiments of the present disclosure has been presented only for the purposes of illustration and description and is not intended to be exhaustive or to limit the present disclosure to the precise forms disclosed. Many modifications and variations are possible in light of the above teaching.

The embodiments were chosen and described in order to explain the principles of the present disclosure and their practical application so as to enable others skilled in the art to utilize the present disclosure and various embodiments and with various modifications as are suited to the particular use contemplated. Alternative embodiments will become apparent to those skilled in the art to which the present disclosure pertains without departing from its spirit and scope.

What is claimed is:

1. An information security threat determination method applicable to a network system including a terminal, a core network and a server, and including following steps:
receiving information about an abnormal event occurring in the network system;
executing a cause and effect tree inspection procedure to generate a plurality of tracing causes according to the abnormal event and deploy a virtual terminal and a virtual server to communicate through the core network to verify whether each tracing cause causes the abnormal event so as to generate an inspection result; and
executing a decision chain procedure to determine the abnormal event as a non-information security threat event or an information security threat event according to the inspection result.

2. The information security threat determination method according to claim 1, wherein the cause and effect tree inspection procedure includes:
executing an analysis procedure for the abnormal event to generate the plurality of tracing causes according to an inspection rule set; and
executing a verification procedure for each tracing cause to verify whether each tracing cause causes the abnormal event.

3. The information security threat determination method according to claim 2, wherein the verification procedure executed for each tracing cause includes an end-to-end probing procedure, and the end-to-end probing procedure includes:
configuring a probe management module to register the virtual terminal to the core network;
configuring the probe management module to deploy the virtual terminal and the virtual server to communicate through the core network according to the abnormal event and the plurality of tracing causes;
the virtual terminal and the virtual server communicating through the core network;
configuring the virtual terminal to transmit uplink data;
configuring the virtual server to analyze the uplink data and report first probing data to the probe management module;
configuring the virtual server to transmit downlink data;
configuring the virtual terminal to analyze the downlink data and report second probing data to the probe management module; and
configuring the probe management module to report the first probing data and the second probing data to a processor, wherein the processor verifies whether each tracing cause causes the abnormal event according to the first probing data and the second probing data.

4. The information security threat determination method according to claim 2, wherein the cause and effect tree inspection procedure further includes:
obtaining a tracing cause set that is verified to cause the abnormal event, and deriving at least one tracing event according to the tracing cause set;
executing the analysis procedure on the at least one tracing event to regenerate the plurality of tracing causes according to the inspection rule set; and
executing the verification procedure for each tracing cause again to verify whether each tracing cause causes the abnormal event.

5. The information security threat determination method according to claim 3, wherein the verification procedure executed for each tracing cause further includes a key data retrieval procedure, and the key data retrieval procedure includes:
obtaining configuration data and real-time operation data of the core network; and
verifying whether each tracing cause causes the abnormal event according to the configuration data and the real-time operation data.

6. The information security threat determination method according to claim 2, wherein the decision chain procedure includes:
executing a labelling procedure to determine and label the abnormal event as a non-information security threat event or an information security threat event according to the inspection result;
executing a training procedure to use the information security threat event as a label and using overall operation data of the network system during the abnormal event as training data to train a machine learning model; and
executing a feedback procedure to update the inspection rule set in the analysis procedure according to the machine learning model.

7. The information security threat determination method according to claim 6, wherein the labelling procedure determines and labels the abnormal event as the information security threat event according to the inspection result in response to that one of the plurality of tracing causes verified to cause the abnormal event is associated to an information security threat.

8. An information security threat determination device applicable to a network system including a terminal, a core network and a server, and including:
a storage configured to store information about an abnormal event occurring in the network system;
a processor electrically connected to the storage and configured to execute following steps:
executing a cause and effect tree inspection procedure to generate a plurality of tracing causes according to the abnormal event and deploying a virtual terminal and a virtual server to communicate through the core network to verify whether each tracing cause causes the abnormal event so as to generate an inspection result; and
executing a decision chain procedure to determine the abnormal event as a non-information security threat event or an information security threat event according to the inspection result.

9. The information security threat determination device according to claim 8, wherein the processor executing the cause and effect tree inspection procedure includes following steps:
executing an analysis procedure for the abnormal event to generate the plurality of tracing causes according to an inspection rule set; and
executing a verification procedure for each tracing cause to verify whether each tracing cause causes the abnormal event.

10. The information security threat determination device according to claim 9, wherein the verification procedure executed for each tracing cause by the processor includes an end-to-end probing procedure, and the end-to-end probing procedure includes:
configuring a probe management module to register the virtual terminal to the core network;
configuring the probe management module to deploy the virtual terminal and the virtual server to communicate through the core network according to the abnormal event and the plurality of tracing causes;
the virtual terminal and the virtual server communicating through the core network;
configuring the virtual terminal to transmit uplink data;
configuring the virtual server to analyze the uplink data and report first probing data to the probe management module;
configuring the virtual server to transmit downlink data;
configuring the virtual terminal to analyze the downlink data and report second probing data to the probe management module; and
configuring the probe management module to report the first probing data and the second probing data to the processor, wherein the processor verifies whether each tracing cause causes the abnormal event according to the first probing data and the second probing data.

11. The information security threat determination device according to claim 9, wherein the processor executing the cause and effect tree inspection procedure further includes following steps:
obtaining a tracing cause set that is verified to cause the abnormal event, and deriving at least one tracing event according to the tracing cause set;
executing the analysis procedure on the at least one tracing event to regenerate the plurality of tracing causes according to the inspection rule set; and
executing the verification procedure for each tracing cause again to verify whether each tracing cause causes the abnormal event.

12. The information security threat determination device according to claim 10, wherein the verification procedure executed for each tracing cause by the processor further includes a key data retrieval procedure, and the key data retrieval procedure includes:
obtaining configuration data and real-time operation data of the core network; and
verifying whether each tracing cause causes the abnormal event according to the configuration data and the real-time operation data.

13. The information security threat determination device according to claim 9, wherein the processor executing the decision chain procedure includes following steps:
executing a labelling procedure to determine and label the abnormal event as a non-information security threat event or an information security threat event according to the inspection result;
executing a training procedure to use the information security threat event as a label and using overall operation data of the network system during the abnormal event as training data to train a machine learning model; and
executing a feedback procedure to update the inspection rule set in the analysis procedure according to the machine learning model.

14. The information security threat determination device according to claim 13, wherein the processor determines and labels the abnormal event as the information security threat event according to the inspection result in response to that one of the plurality of tracing causes verified to cause the abnormal event is associated to an information security threat.
